(19) United States
(12) Patent Application Publication
(10) Pub. No.: US 2006/0242034 A1
(43) Pub. Date: Oct. 26, 2006

(54) Electronic account book generating system and method

(75) Inventors: Jih-Hong Huang, Taipei (TW); Jung-Chun Hung, Taipei (TW); Shiou-Yu Hung, Taipei (TW); Shu-Hui Chuang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/096,692

(22) Filed: Mar. 31, 2005

(51) Int. Cl. G07F 19/00; G07B 17/00

(52) U.S. Cl. 705/30

(57) ABSTRACT

An electronic account book generating method for providing a user at a terminal device to connect to the generating system through a network to control import/export operation, thereby accelerating the speed of declaration and upgrading the ability of keeping data of the import/export commodities and materials, the method comprising the steps of: establishing an import/export commodity database for storing data including name of import/export commodity and related information; establishing a basic commodity database for storing data including name of import/export commodity and the component materials thereof; establishing a Customs commodity classification database for storing information on Customs materials classification; obtaining name of import/export commodity and the component materials thereof; obtaining a corresponding materials classification, wherein, the system adds up the quantity of different materials having identical classification and combines those materials into the same category; and establishing Customs declaration data according to the result of the processed materials classification.

### FIELD OF THE INVENTION

The present invention relates to electronic account book generating systems and methods, and more particularly, it relates to an electronic account book generating system and method that can facilitate and accelerate the process of declaration at the Customs, thereby saving time, storage space of paper documents, paper resources and materials as a result.

### BACKGOUND OF THE INVENTION

In order to promote the business and gain more opportunities, enterprises are moving toward multinational evolution that has become a mainstream of business since the local development can no longer satisfy the enterprises' needs. Consequently, the operation and management of import/export commodities and materials become more frequent and essential.

On the other hand, the Customs declaration operation is internationally performed in order to control flow of dealings and the origin of commodities and materials that are being imported and exported. Traditional importers/exporters usually use paper documents to perform declarations with the Customs for commodities and materials to be imported or exported. However, in conducting the Customs declaration, if the content of a certified document provided by an importer/exporter does not comply with the regulations of the Customs, such as a mistake in the Customs materials classification or in the sum of materials quantity, the importer/exporter is required to correct the Customs document, thereby causing great inconveniences and hindering the process of declaration through the Customs. Even if the papers are found in order and correct, the Customs or the importer/exporter has to retain the Customs documents for records, which will not only waste the paper material but also occupy storage space.

Therefore, how to prevent the drawbacks of occupying storage space and wasting paper resources and to facilitate the process of declaration of the import/export commodities and materials at the Customs, is a critical issue to solve.

### SUMMARY OF THE INVENTION

In order to solve the foregoing drawbacks, the electronic account book generating system and method of the present invention are provided for a unit of the Customs and an importer/exporter at a terminal device to connect via a network system, so as to efficiently control the import/export operation, thereby accelerating the speed of Customs declarations and upgrading the ability of keeping data of the import/export commodities and materials.

The electronic account book generating system includes: an import/export commodity database for storing data at least including name of import/export commodity and related information; a basic commodity database for storing data at least including name of import/export commodity and the component materials required for making the commodity; a Customs commodity classification database for storing information on Customs materials classification; a materials inventory displaying module for obtaining name of import/export commodity, and then obtaining the component materials thereof from the basic commodity database according to name of commodity obtained from the import/export commodity database, so as to acquire the component materials thereof; a combining processing module for obtaining a corresponding Customs materials classification from the Customs commodity classification database according to the materials classification obtained from the materials inventory displaying module, wherein, the combining processing module adds up the quantity of different materials having identical classification and combine those materials into the same category; a file-establishing module for establishing Customs declaration data according to the result of materials classification processed by the combining processing module; and, a Customs database for storing Customs declaration data established by the file-establishing module.

An electronic account book generating method is implemented using the electronic account book generating system for providing a unit of the Customs and an importer/exporter at a terminal device to connect to the electronic account book generating system through a network system to monitor and control the import/export operation, thereby accelerating the speed of declaration and upgrading data-keeping of the import/export commodities and materials. The electronic account generating method of the present invention comprises the steps of: establishing an import/export commodity database for storing data at least including name of import/export commodity and related information; establishing a basic commodity database for storing data at least including name of import/export commodity and the component materials required for making a commodity; establishing a Customs commodity classification database for storing information on Customs materials classification; obtaining name of import/export commodity from the import/export commodity database, and then obtaining the component materials thereof from the basic commodity database according to name of commodity; obtaining a corresponding materials classification from the Customs commodity classification database, wherein, the system adds up the quantity of different materials having identical classification and combines those materials into the same category; establishing data of Customs declarations according to the result of materials classification, thereby enabling a unit of the Customs and an importer/exporter to conduct declaration of the import/export commodities and the component materials thereof accordingly.

### BRIEF DESCRIPTIONS OF THE DRAWINGS

The present invention can be more fully understood by reading the following detailed description of the preferred embodiments, with reference made to the accompanying drawings, wherein:

FIG. 1 is a schematic block diagram showing the basic architecture of an electronic account book generating system of the present invention;

FIG. 2 is a schematic diagram showing an exemplar of a materials inventory generated by a combining processing module shown in FIG. 1, after combining different materials of an import/export commodity having identical classification in the same category;

FIG. 3 is a schematic flow diagram showing the operational steps in performing an electronic account book generating method of the present invention; and

FIG. 4 is a schematic flow diagram depicting in detail the steps S5 and S6 shown in FIG. 3 in performing an electronic account book generating method of the present invention.

### EMBODIMENTS OF THE INVENTION

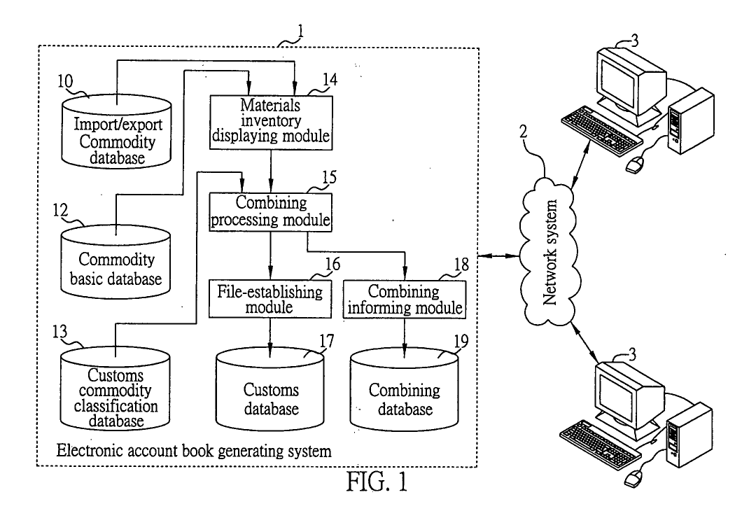

FIG. 1 illustrates the basic architecture of the electronic account book generating system of the invention. As shown, the electronic account book generating system 1 is provided for a unit of the Customs or an importer/exporter at a terminal device 3 to control the import/export operation of commodities via a network system 2. The generating system 1 comprises an import/export commodity database 10, a commodity basic database 12, a Customs commodity classification database 13, a materials inventory displaying module 14, a combining processing module 15, a file-establishing module 16, a Customs database 17, a combining informing module 18, and a Combining database 19. It is to be noted that, in order to simplify the description and the accompanying drawings, the following description only shows functional modules that are directly related to the invention and other modules that are not shown and omitted herein, such as an identity identification module that is required for login to the electronic account book generating system 1 and a browsing software required for operating the terminal device 3.

The import/export commodity database 10 is used to store related information of commodities that are to be imported or exported. The related information include name of buyer, address of buyer, name of commodity and quantity of commodity; or it may also include name of supplier, address of supplier, name of commodity and quantity of commodity, etc.

The commodity basic database 12 is used to store the basic information of commodities, in general, information of the component materials that are required for producing the commodity. Moreover, the commodity can be an individual product or a finished product, the individual product refers to a main equipment such as a computer motherboard whereas the finished product refers to a main equipment plus the relative accessories attached thereto on delivery, such as a power supply, a central processing unit, casings and a mouse that are required for the computer motherboard. As such, the foregoing main equipment and the relative accessories thereto represent the component materials necessary for making the commodity. The basic information of commodities include name of commodity and the component materials thereof that include name of material, serial number of material, type of material, weight of material and size of material, etc.

The Customs commodity classification database 13 is used to store information on Customs materials classification that include name of material and the corresponding component materials including serial number of material and type of material, etc., wherein the information on Customs materials classification is the commodity data defined by the Customs.

For brevity and simplicity of the description and the drawings, the foregoing database is depicted to only store the contents of commodities and materials that are directly related to the electronic account book generating system 1. The actual information and contents stored in the database will vary depending on the import/export commodity and operation in practice. For example, the commodity basic database 12 not only can store related information of the individual product that include a power supply, a central processing unit, casings and a mouse, but can also store information of the component materials for making the product, such as a light-emitting diode or a chip for special use.

The materials inventory displaying module 14 is used to obtain from the commodity database 10 information on name of an import/export commodity, and then obtain the component materials required for making the commodity from the commodity basic database 12.

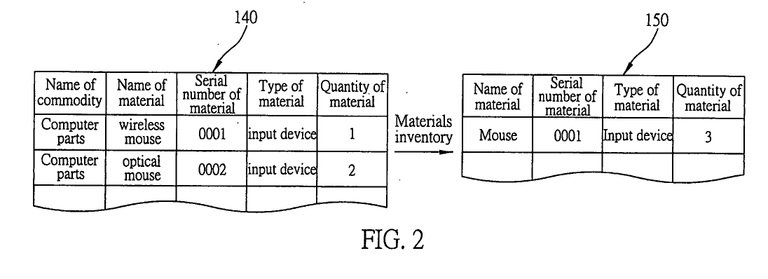

The combining processing module 15 is used to obtain information on the corresponding Customs materials classification stored in the Customs commodity classification database 13 according to the acquired materials data from the materials inventory displaying module 14. For the convenience of managing the import/export commodity and materials, importers/exporters usually set up their own commodity or materials serial numbers which are different from serial numbers of Customs commodity and materials, or do not comply with the regulations of the Customs. Therefore, the combining processing module 15 can automatically convert the self-created serial numbers of commodities and materials made by importers/exporters into Customs commodities and materials serial numbers, wherein, the combining processing module 15 combines different materials having identical classification into the same category by adding up the quantity in accordance with a materials inventory 140 and a combining inventory 150 depicted in FIG. 2, wherein the materials inventory 140 is generated by first obtaining related information on name of an import/export commodity stored in the commodity database 10, and obtaining the component materials required for making the commodity in the commodity basic database 12; and, according to the materials inventory 140, the combining processing module 15 obtains from the Customs commodity classification database 13 information on the corresponding Customs materials classification. As indicated in the materials inventory 140, a wireless mouse and an optical mouse are of the same classification (both are input devices), therefore, the combining processing module 15 adds the quantity of the wireless mouse and the optical mouse and combine the two different materials having identical classification into the same category. Further, according to information on Customs materials classification stored in the Customs commodity classification database 13, a combining inventory 150 depicted in FIG. 2 is established to redefine the name, serial number, and quantity of the combined materials.

The file-establishing module 16 is used to establish and store data of Customs declarations in a Customs database 17 according to the processed result of materials classification made by the combining processing module 15, thereby allowing an importer/exporter or a unit of the Customs at a terminal device 3 to connect to the system 1 via a network system 2, and further store the electronic Customs declaration data in the Customs database 17.

The combining informing module 18 is used to generate a signal by transmitting via the network system 2 to inform the import/export department at a terminal device 3 of the combined materials processed by the combining processing module 15, and, further store the processed information into a combining database 19, thereby allowing the import/export department to be informed in real time the difference of information on Customs commodity and materials classification stored in the commodity database 10 and the Customs database 17.

Further, when the combining informing module 18 is unable to obtain a corresponding information on Customs materials classification from the Customs commodity classification database 13 according to the acquired materials classification from the materials inventory displaying module 14, it generates a signal to inform the import/export department at the terminal device 3 by transmitting through the network system 2, and, further, store and combine the information on Customs materials classification that cannot be found from the Customs commodity classification database 13 in a combining database 19, thereby informing the import/export department of the disaccord of information on Customs materials classification such that revisions or establishment of new materials classification can be made.

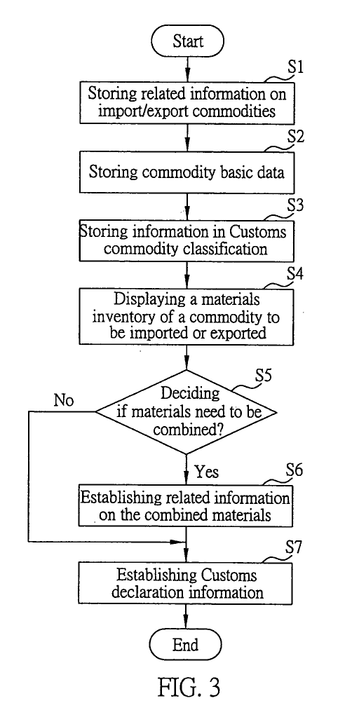

FIG. 3 illustrates the operational steps necessary for performing an electronic account book generating method of the present invention. As shown, first in step S1, an import/export commodity database is established for storing data that include name of import/export commodity and the related information that include name of buyer, address of buyer, name of commodity and quantity of commodity, etc. Further, related information may also include supplier of commodity, address of supplier, name of commodity, and quantity of commodity, etc. Thereafter, step S2 is proceeded.

In step S2, a basic commodity database is established for storing the basic information on the import/export commodities that include name of commodity and the corresponding component materials thereof that include name of material, serial number of material, type of material, weight of material and size of material, etc. Thereafter, step S3 is followed.

In step S3, a Customs commodity classification database is established for storing information on Customs materials classification which include name of material and the corresponding component materials thereof that include serial number of material and type of material, etc. Thereafter, step S4 is followed.

In step S4, the name of an import/export commodity is obtained from the import/export commodity database 10 via the materials inventory displaying module 14, thereby obtaining the component materials of the commodity from the basic commodity database 12 according to name of commodity in order to display the required materials inventory for the import/export commodity. Thereafter, step S5 is followed.

In step S5, the combining processing module 15 decides if the component materials of an import/export commodity need to be combined and processed, if yes, step S6 is proceeded; or else, step S7 is entered.

In step S6, the combining processing module 15 adds up the quantity of different materials having identical classification and combines those materials into the same category. Thereafter, step S7 is followed.

In step S7, data of Customs declarations is established via the file-establishing module 16 according to the result of processed materials classification, thereby enabling a unit of the Customs or an importer/exporter at a terminal device 3 to connect to the electronic book generating system 1 via a network system 2 to store the electronic data of Customs declarations.

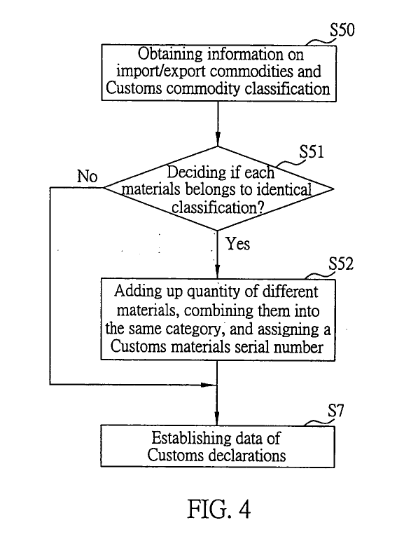

FIG. 4 illustrates in detail the steps S5 and S6 depicted in FIG. 3 for performing a combining process of the electronic account book generating method of the invention. First, in step S50, the combining processing module 15 obtains the corresponding information on Customs materials classification stored in the Customs commodity classification database 13 according to the acquired materials data and materials classification from the materials inventory displaying module 14. Thereafter, step S51 is followed.

In step S51, the combining processing module 15 decides if there are different materials that have identical classification from the acquired information on Customs materials classification, and, if yes, step S52 is proceeded; or else, step S7 as shown in FIG. 3 is returned.

In S52, the combining processing module 15 adds up the quantity of different materials having identical classification and combines those materials into the same category, further assigning a serial number to Customs commodity materials. Subsequently, step S7 as shown in FIG. 3 is returned.

In conclusion, the electronic account book generating system and method of the invention are beneficial to implement by providing electronic Customs declaration without having to use paper documents in the process of Customs declaration, thereby saving storage space of paper documents and effectively increasing work efficiency in using and preserving data of Customs declarations. Further, the electronic account book generating system and method of the invention can automatically convert different formats of Customs declaration documents used by importers/exporters to a standard format that complies with the regulations of Customs, thereby eliminating errors in the documents and expediting the speed of Customs declarations as a result.

The invention has been described using exemplary preferred embodiments. However, it is to be understood that the scope of the invention is not limited to the disclosed embodiments. On the contrary, the scope claims should be accorded the broadest interpretation so as to encompass all such modifications and similar arrangements.

What is claimed is:

1. An electronic account book generating system, for allowing a unit of the Customs and an importer/exporter at a terminal device to connect via a network system, so as to efficiently control the import/export operation, thereby accelerating the speed of Customs declarations and upgrading the ability of keeping data of the import/export commodities and materials, the system comprising:
an import/export commodity database for storing data at least including name of the import/export commodity and related information;
a basic commodity database for storing data at least including name of the import/export commodity and the component materials required for making the commodity;
a Customs commodity classification database for storing information on Customs materials classification;
a materials inventory displaying module for obtaining name of import/export commodity, and then obtaining the component materials thereof from the basic commodity database according to name of the commodity obtained from the import/export commodity database, so as to acquire the component materials thereof;
a combining processing module for obtaining a corresponding Customs materials classification from the Customs commodity classification database according to the result of materials classification obtained from the materials inventory displaying module, wherein, the combining processing module adds up the quantity of different materials having identical classification and combine those materials into the same category;
a file-establishing module for establishing Customs declaration data according to the result of materials classification processed by the combining processing module; and,
a Customs database for storing Customs declaration data established by the file-establishing module.

2. The electronic account book generating system of claim 1, further comprising a combining informing module for generating a signal to inform by transmitting via the network system to an importer/exporter at a terminal device when the combining processing module adds up quantity of different materials having identical classification and combines them into the same category.

3. The electronic account book generating system of claim 2, wherein the combining informing module further comprises a step of generating a signal to inform an importer/export at a terminal device via the network system when the combining processing module cannot obtain the corresponding Customs materials classification from the Customs commodity classification database according to the acquired materials obtained from the materials inventory displaying module.

4. The electronic account book generating system of claim 1, wherein the information on Customs materials classification stored in the Customs commodity classification database are serial numbers of materials and the corresponding names thereof defined by the Customs, thereby allowing the combining processing module to obtain information on materials serial numbers and the corresponding names thereof for establishing Customs declaration data from the information on Customs materials classification stored in the Customs commodity classification database according to the acquired materials classification obtained from the materials inventory displaying module.

5. An electronic account book generating method, for providing a unit of the Customs or an importer/exporter at a terminal device to connect to the electronic account book generating system through a network system to monitor and control the import/export operation, thereby accelerating the speed of declaration and upgrading the ability of keeping data of the import/export commodities and materials, the method comprising the steps of:
establishing an import/export commodity database for storing data at least including name of import/export commodity and related information;
establishing a basic commodity database for storing data at least including name of import/export commodity and the component materials required for making a commodity;
establishing a Customs commodity classification database for storing information on Customs materials classification; obtaining the name of an import/export commodity from the import/export commodity database, and then obtaining the component materials thereof from the basic commodity database according to name of the commodity;
obtaining a corresponding materials classification from the Customs commodity classification database, wherein, the system adds up the quantity of different materials having identical classification and combines those materials into the same category; and
establishing Customs declaration data according to the result of materials classification, thereby enabling a unit of the Customs and importers/exporters to conduct declarations of the import/export commodities and the component materials thereof accordingly.

6. The electronic account book generating method of claim 5, further comprising a step of generating a signal to inform an importer/exporter at a terminal device by transmitting via the network system when the combining processing module adds up quantity of different materials having identical classification and combines them into the same category.

7. The electronic account book generating method of claim 5, further comprising a step of generating a signal to inform an importer/export at a terminal device by transmitting via the network system when the combining processing module cannot obtain the corresponding Customs materials classification from the Customs commodity classification database according to the acquired materials classification obtained from the materials inventory displaying module.

8. The electronic account book generating method of claim 5, wherein the information on Customs materials classification stored in the Customs commodity classification database are serial numbers of materials and the corresponding names thereof defined by the Customs, thereby allowing the combining processing module to obtain information on materials serial numbers and the corresponding names thereof for establishing Customs declaration data from the information on Customs materials classification stored in the Customs commodity classification database according to the acquired materials classification obtained from the materials inventory displaying module.
